(19) United States
(12) Patent Application Publication
(10) Pub. No.: US 2021/0276372 A1
(43) Pub. Date: Sep. 9, 2021

(54) SYSTEM AND METHOD FOR OPTIMIZATION OF TIRE ROLLING RESISTANCE

(71) Applicant: PACCAR Inc, Bellevue, WA (US)

(72) Inventor: Jeffrey P. Smith, Prosper, TX (US)

(73) Assignee: PACCAR Inc, Bellevue, WA (US)

(21) Appl. No.: 16/807,983

(22) Filed: Mar. 3, 2020

(51) Int. Cl. B60C 23/00

(52) U.S. Cl. CPC B60C 23/003

(57) ABSTRACT

Systems and methods for inflating a tire to an operating pressure that is above a cold inflation tire pressure are provided. More specifically, the system may include a tire pressure sensor coupled to a vehicle tire, a compressor configured to provide compressed air to the vehicle tire, a valve between the compressor and the vehicle tire; and a controller configured to: access a tire parameter associated with the vehicle tire, receive a tire pressure of the vehicle tire from the tire pressure sensor, and when then tire pressure received from the tire pressure is less than an operating tire pressure that is based on the accessed tire parameter, cause the valve to pass pressurized air from the compressor to the vehicle tire, wherein the operating tire pressure is greater than a cold inflation tire pressure of the vehicle tire.

### BACKGROUND

Underinflated tires negatively impact handling characteristics of private and commercial vehicles and may significantly decrease overall vehicle safety. Further, underinflated tires may decrease tire life by negatively impacting a rate at which tire tread wears, for example. Similarly, underinflated tires may cause poor vehicle fuel efficiency and are one of the significant factors contributing to decreased freight ton efficiency for commercial vehicles. Accordingly, tires inflated to the proper pressure as directed by a tire manufacturer may provide better vehicle handling characteristics, extend the tire life expectancy, and increase vehicle fuel efficiency.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for monitoring and then increasing a tire pressure to a pressure above a manufacture's recommended cold inflation pressure to reduce a tire's rolling resistance. The cold inflation pressure may be the inflation pressure of a tire that exists before the vehicle is driven. When a vehicle is operated over an extended period of time, the pressure of the tire often increases above the manufacturer's recommended cold inflation pressure to a greater operating pressure; this increase in tire pressure may contribute to increases in fuel efficiency and/or freight ton efficiency of the vehicle. However, the period of time that is required for the tire pressure to increase above the cold inflation pressure to the greater operating pressure may be relatively long and may be impacted by external factors such as air temperature and wet pavement. In some instances, the greater operating pressure may not be obtainable if the weather is cold and the pavement is wet for example. Further, while the vehicle is operating with tires having pressures that are lower than the greater operating pressure, the overall fuel efficiency and freight ton efficiency of the vehicle is reduced.

Examples and aspects presented herein are directed to a tire inflation system including a tire pressure sensor coupled to a vehicle tire, a compressor configured to provide compressed air to the vehicle tire, a valve between the compressor and the vehicle tire, and a controller. The controller may be configured to access a tire parameter associated with the vehicle tire, determine a cold inflation tire pressure of the vehicle tire, determine an operating tire pressure for the vehicle tire based on the accessed tire parameter and the cold inflation tire pressure, receive a tire pressure of the vehicle tire from the tire pressure sensor, and when then tire pressure received from the tire pressure is less than an operating tire pressure, cause the valve to pass pressurized air from the compressor to the vehicle tire, wherein the operating tire pressure is greater than a cold inflation tire pressure of the vehicle tire.

In accordance with at least one example of the present disclosure, a method for inflating a vehicle tire is provided. The method may include accessing a tire parameter associated with the vehicle tire; determining a cold inflation tire pressure of the vehicle tire; determining an operating tire pressure for the vehicle tire based on the accessed tire parameter and the cold inflation tire pressure; receiving a tire pressure of the vehicle tire from a tire pressure sensor; and when the tire pressure received from the tire pressure sensor is less than the operating tire pressure, causing a valve to pass pressurized air from a compressor to the vehicle tire, wherein the operating tire pressure is greater than the cold inflation tire pressure of the vehicle tire.

In accordance with at least one example of the present disclosure, a vehicle is provided. The vehicle may include a plurality of vehicle tires, a plurality of tire pressure sensors, each pressure sensor of the plurality of pressure sensors being coupled to a vehicle tire of the plurality of vehicle tires, a compressor configured to provide compressed air to the plurality of vehicle tires, at least one valve between the compressor and the plurality of vehicle tires, and a controller. The controller may be configured to: access a tire parameter associated with each vehicle tire of the plurality of vehicle tires; determine a cold inflation tire pressure of the vehicle tire; determine an operating tire pressure for the vehicle tire based on the accessed tire parameter and the cold inflation tire pressure; receive a tire pressure of each vehicle tire from a respective tire pressure sensor; and when a tire pressure of a respective vehicle tire is less than the operating tire pressure, cause the at least one valve to pass pressurized air from the compressor to the vehicle tire, wherein the operating tire pressure is greater than the cold inflation tire pressure of the respective vehicle tire.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 depicts a semi-truck and trailer in accordance with examples of the present disclosure;

FIG. 2 depicts an example vehicle tire in accordance with examples of the present disclosure;

FIG. 3 depicts a graph of an internal air pressure of a vehicle tire over time in accordance with examples of the present disclosure;

FIG. 4 depicts another graph of an internal air pressure of a vehicle tire over time in accordance with examples of the present disclosure;

FIG. 5 depicts another graph of an internal air pressure of a vehicle tire over time in accordance with examples of the present disclosure;

FIG. 6 depicts an example of an automatic tire inflation system in accordance with examples of the present disclosure;

FIG. 7 depicts another example of an automatic tire inflation system in accordance with examples of the present disclosure;

FIG. 8 depicts another example of an automatic tire inflation system in accordance with examples of the present disclosure;

FIG. 9 depicts another example of an automatic tire inflation system in accordance with examples of the present disclosure;

FIG. 10 depicts a user interface for interacting with one or more of the automatic tire inflation systems in accordance with examples of the present disclosure;

FIG. 11 depicts a computing environment that may be used in accordance with examples of the present disclosure;

FIG. 12 illustrates a computer system and/or controller in accordance with examples of the present disclosure;

FIG. 13 illustrates a data structure in accordance with examples of the present disclosure;

FIG. 14 depicts a method for adjusting an air pressure of one or more vehicle tires in accordance with examples of the present disclosure; and

FIG. 15 depicts a method for providing and/or updating one or more tire parameters for one or more vehicle tires of a vehicle in accordance with examples of the present disclosure.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, a software implementation, or an implementation combining software and hardware aspects. The following detailed description is, therefore, not to be taken in a limiting sense.

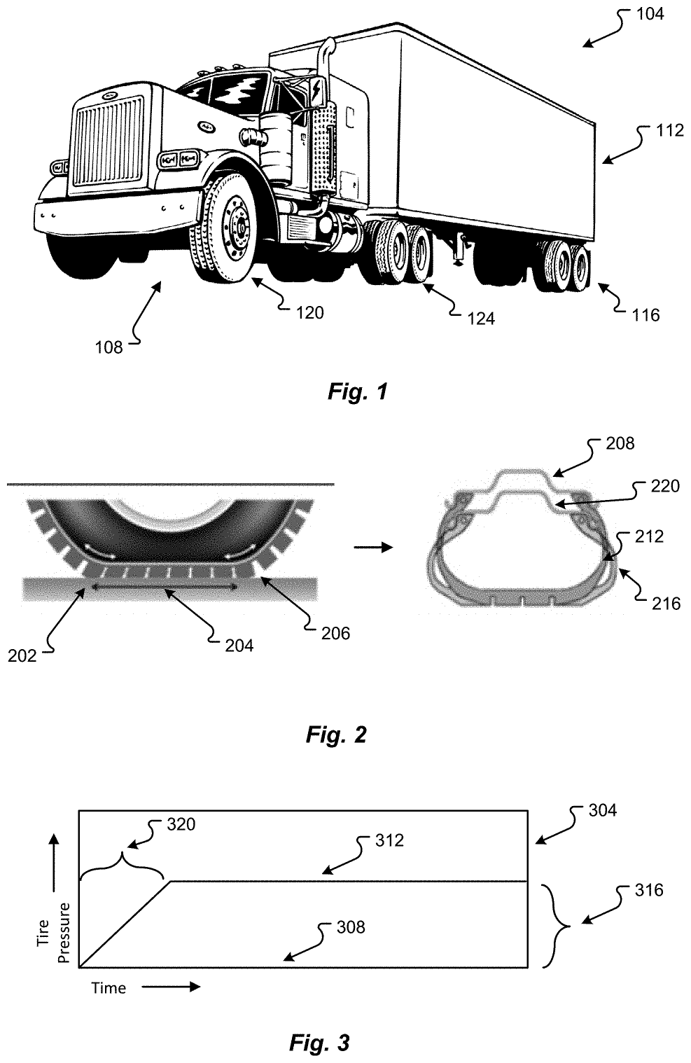

FIG. 1 depicts a semi-truck and trailer 104 in accordance with examples of the present disclosure. The semi-truck and trailer 104 may include a tractor 108 and trailer 112. The tractor 108 generally includes steer tires 120 and drive tires 124. The steer tires 120 provide steering to the tractor 108 and generally influence the ride and handling of the tractor 108. The drive tires 124 may reside on drive, or torque axles, and generally are responsible for pushing the tractor 108 and pulling the trailer 112; the drive tires 124 may be designed to maximize traction levels on various surfaces. The trailer tires 116 are generally designed to carry varying loads of the trailer 112. While FIG. 1 depicts a semi-truck and trailer 104, one of skill in the art will appreciate that the present systems and methods are applicable to any vehicle employing pneumatic tires, including (among others) passenger cars, buses, utility vehicles, and the like.

A tire rolling resistance of each tire of the vehicle, such as tractor 108 and trailer 112, may impact overall fuel and freight ton efficiency of the semi-truck and trailer 104. Tire rolling resistance generally refers to an amount of energy provided to one or more tires to maintain movement at a consistent speed over a surface; that is, the effort required to keep a tire rolling. A tire's rolling resistance affects fuel economy. While many factors influence tire rolling resistance, hysteresis generally influences the tire rolling resistance the most. Hysteresis may refer to the energy loss that occurs as a tire rolls through its footprint. That is, hysteresis losses from the rubber in the tire may cause energy dissipation, and therefore energy losses, in the form of heat. As depicted in FIG. 2, at each rotation of a tire, there is a contact patch 204 formed between the entry bend 202 and the exit bend 206. The bending of the tire at each bend location, the entry bend 202 and the exit bend 206, results in heat. In addition, the sidewall of the tire between the entry bend 202 and the exit bend 206 collapses as depicted as tire portion 216 in FIG. 2. The bending at the various locations of the contact patch 204 and collapsing of the sidewall are the primary contributors to the rolling resistance of a tire. In addition, other factors that influence the rolling resistance may include, but are not limited to the material of the tire, for example the rubber compound utilized, the tire construction, the steel pattern, and the resistance caused by tread and the tire material.

Tire pressure also contributes to the rolling resistance of the tire. That is, the higher the air pressure within the tire, typically, the lower the rolling resistance will be because the contact patch tends to be smaller and the collapsing of the sidewall may be less. Accordingly, there is less flexing of the crown of the tire at the entry and exit points of the contact patch and the bulge of the sidewall formed when the sidewall collapses is less; that is, there is less flexing at the bulge of the tire. As depicted in FIG. 2, a tire 208 having a first tire pressure is depicted having a bulge 212. A tire 220 having a second tire pressure less than the first tire pressure is depicted having a bulge. Accordingly, a tire having a greater internal air pressure may have a smaller sidewall bulge which may reduce an amount of heat generated and energy dissipated by the collapsing sidewall. As one non-limiting example, if an internal tire pressure is increased by about 20 pounds per square inch (PSI), the tire rolling resistance may be reduced by about 3%. By reducing the tire rolling resistance, the fuel economy and freight ton efficiency of the vehicle may be increased.

In accordance with examples of the present disclosure, when a tire rolls, the tire creates heat due at least in part to the bending of the crown at the entry and exit points as well as the collapsing of the sidewall as previously discussed. In some instances, the heat may be absorbed into the contained air inside the tire, and as a result of the heat absorption, the internal tire pressure may naturally increase due to thermodynamics and the increase in temperature of a contained gas. After the tire has been in use for a period of time, for example an hour, the operating tire pressure may be greater than the cold inflation pressure, where the cold inflation pressure may be a recommended or desired air pressure of a tire when the tire is cold or otherwise has not been recently used, and the operating tire pressure is the tire pressure of the tire after the tire has been used or otherwise has been rolling for a period of time. As depicted in FIG. 3, a graph 304 of the internal air pressure of a tire over time is illustrated in accordance with examples of the present disclosure. That is, a cold inflation tire pressure corresponding to 308 may be less than an operating tire pressure 312. As a tire rolls or is otherwise in operation, for example for a period of time corresponding to 320, the internal air pressure of the tire may increase by an amount 316. Because the internal air pressure of the tire is increased, the tire may exhibit lower rolling resistance characteristics and contribute to increased fuel efficiency and freight ton efficiency of a vehicle.

In accordance with examples of the present disclosure, an automatic tire inflation system is presented for achieving and maintaining an ideal internal tire pressure that is greater than a cold inflation tire pressure. That is, examples presented herein actively increase the internal tire pressure of a tire to a desired operating pressure, which could be 20 PSI, 30 PSI, or more greater than a tire's cold inflation pressure. Rather than relying on tire operation and thermodynamics to achieve the operating tire pressure, automatic tire inflation systems presented herein inflate the tire to the operating pressure; that is, low rolling tire resistance characteristics similar to those characteristics of a tire that has been driven for an hour may be achieved without the expense of time and fuel efficiency to do so. Additionally, low rolling tire resistance characteristics of a tire may be achieved in instances where the tire is otherwise unable to achieve a desired operating pressure due to use alone, such as when the tire cannot heat up in the winter, the tire is wet, or other instances where the heat is drawn off too quickly to naturally cause an increase in tire pressure. Thus, in accordance with examples of the present disclosure, the automatic tire inflation system causes the tire to achieve the desired operating pressure immediately and to realize the reduction in tire rolling resistance from (or near) the start of a drive, rather than waiting the hour (or thereabouts) to heat up during normal operating conditions.

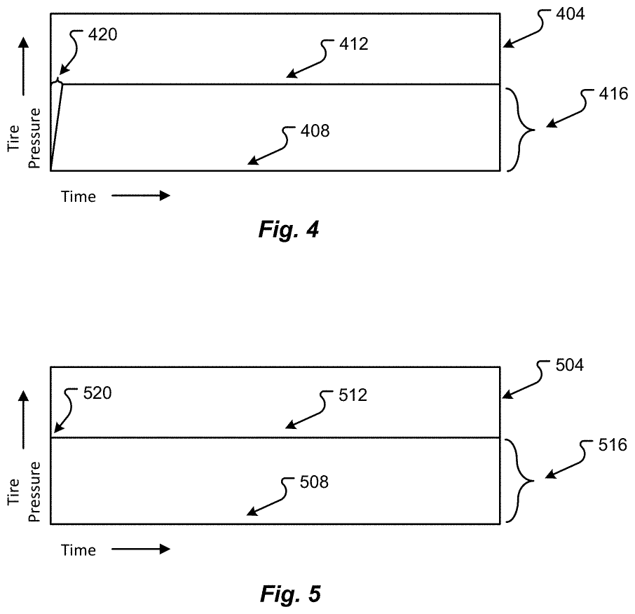

For example, and as depicted in graph 404 of FIG. 4, a tire may be inflated from a cold inflation tire pressure 408 to a desired operating pressure 412 over a period of time 420, where the period of time 420 is less than the period of time 320 of FIG. 3. Accordingly, an increase in a tire pressure corresponding to 416 may be realized in a shorter period of time. As further depicted in graph 504 of FIG. 5, a tire may be inflated from a cold inflation tire pressure 508 to a desired operating pressure 512 over a period of time 520, where the period of time 520 is less than the period of time 420 of FIG. 4 and may be as little as zero if the tire is inflated to the desired operating pressure 512 before a trip is started. Accordingly, an increase in a tire pressure corresponding to 516 may be realized in a short period of time.

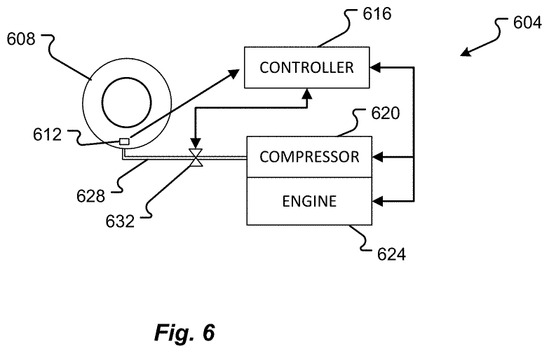

FIG. 6 depicts a first example of an automatic tire inflation system 604 in accordance with examples of the present disclosure. The automatic tire inflation system 604 generally acts on the tire 608; a tire pressure sensor 612 may provide a measurement, or quantity, of an internal tire pressure to a controller 616. For example, the tire pressure sensor 612 may measure an internal tire pressure and provide an indication, signal, or otherwise indicative of an internal tire pressure of the tire 608 to the controller 616. The indication, signal, or otherwise may be in the form of an analog or digital signal or quantity representative of the internal tire pressure of the tire 608. In some aspects, the controller 616 may cause the received tire pressure from the tire pressure sensor 612 to be stored in memory, a database, and/or provided to another device, such as a server, database, or otherwise, that is separate and distinct from the automatic tire inflation system 604. For example, the controller 616 may communicate with a network and provide such measured and received tire pressure to another location communicatively coupled to the network.

In some examples, the controller 616 may determine, calculate, or otherwise generate a desired quantity corresponding to an operating tire pressure based on the received tire pressure. In some examples, the desired quantity corresponding to the operating tire pressure may be based on additional parameters, such as weather conditions, tire type, tire location, tire condition (tread condition), load, pavement, etc. The desired quantity, for example, may be the desired operating tire pressure, a total amount of additional air necessary to reach the operating tire pressure, and/or a difference between the sensed pressure and the desired operating tire pressure. In some examples, the controller 616, based on the received tire pressure, may cause a regulator or valve 632 to open or close. That is, pressurized air may be provided by a compressor 620 communicatively coupled to the tire 608 via an air pressure line 628. As used herein, and unless otherwise specified, a “compressor” includes any system capable of providing pressurized air, including, without limitation any type of air pump. The regulator or valve 632 may regulate an amount of pressurized air that flows from the compressor 620 via the air pressure line 628 to the tire 608. The tire 608 may include a tire stem coupled to the air pressure line 628 such that the tire stem may provide a pathway for pressurized air to enter the tire 608 and/or exit the tire 608 while the tire 608 is rotating for example. In some instances, the tire stem may allow pressurized air to escape from the tire 608 via the regulator or valve 632, which may act as a pressure bleeder valve for example, to bleed excess tire pressure from the tire 608. In examples, the compressor 620 may be operatively coupled to a power takeoff of the engine 624 of the vehicle, such as tractor 108, where the engine 624 may provide the necessary energy or power to compress air. In other examples, the compressor 620 may be separately powered, such as through a battery. Although the controller 616 is depicted controlling an air pressure of a single tire 608, it should be understood that the controller 616 may control the air pressure of multiple tires of the vehicle, such as tractor 108 and the trailer 112. Alternatively, or in addition, a single controller 616 may control the air pressure of a single tire 608.

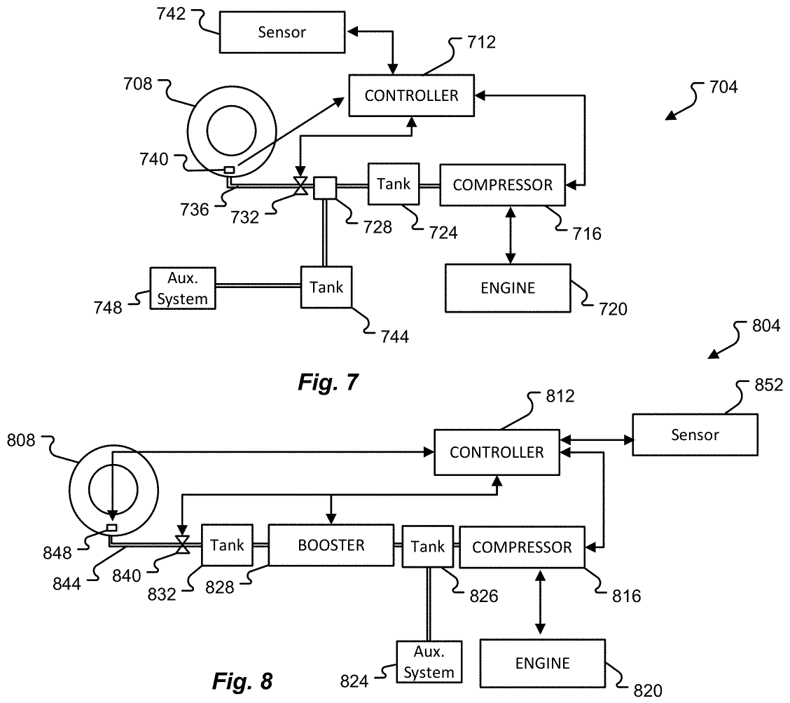

FIG. 7 depicts a second example of an automatic tire inflation system 704 in accordance with examples of the present disclosure. Similar to the automatic tire inflation system 604, the automatic tire inflation system 704 generally acts on the tire 708; a tire pressure sensor 740 may provide a measurement, or quantity, of an internal tire pressure to a controller 712. For example, the tire pressure sensor 740 may measure an internal tire pressure and provide an indication, signal, or otherwise indicative of an internal tire pressure of the tire 708 to the controller 712. The indication, signal, or otherwise may be in the form of an analog or digital signal or quantity representative of the internal tire pressure of the tire 708. In some aspects, the controller 712 may cause the received tire pressure from the tire pressure sensor 740 to be stored in memory, a database, and/or provided to another device, such as a server, database, or otherwise, that is separate and distinct from the automatic tire inflation system 704. For example, the controller 712 may communicate with a network and provide such measured and received tire pressure to another location communicatively coupled to the network.

In some examples, the controller 712 may determine, calculate, or otherwise generate a desired quantity corresponding to an operating tire pressure based on the received tire pressure. The desired quantity, for example, may be the desired operating tire pressure, a total amount of additional air necessary to reach the operating tire pressure, and/or a difference between the sensed pressure and the desired operating tire pressure. In some examples, the desired quantity corresponding to the operating tire pressure may be based on additional parameters, such as weather conditions, tire location, tire type, tire condition (tread condition), load, pavement, etc. from a sensor 742. In some examples, the controller 712, based on the received tire pressure, may cause a regulator, or valve, 732 to open or close. That is, pressurized air may be provided by a compressor 716 communicatively coupled to the tire 708 via an air pressure line 736. The compressor 716 may provide, or pass, pressured air equal that is greater than the desired operating pressure to a pressured air tank, or reservoir 724. That is, the air tank, or reservoir, 724 may store pressurized air equal to or greater than the determined desired operating tire pressure.

In some examples of the present disclosure, the desired operating tire pressure, such as the desired operating pressure 412 and/or 512, may be greater than an air pressure provided to one or more auxiliary systems 748, such a braking system, horn system, suspension system etc. Accordingly, a regulator 728 may provide pressurized air to an air tank or reservoir 744. The air tank or reservoir 744 may store pressured air at a pressure that is different from the air tank or reservoir 724, and provide such pressurized air to one or more auxiliary systems 748. Thus, pressurized air corresponding to a desired operating tire pressure may be provided from the air tank, or reservoir, 724 to a regulator, or valve, 732. The regulator, or valve 732, may provide a regulated amount of pressurized air from the compressor 716 via the air pressure line 736 to the tire 708. The tire 708 may include a tire stem coupled to the air pressure line 736 such that the tire stem may provide a pathway for pressurized air to enter the tire 708 and/or exit the tire 708 while the tire 708 is rotating for example. In some instances, the tire stem may allow pressurized air to escape from the tire 708 via the regulator, or valve, 732 which may act as a pressure bleeder valve for example, to bleed excess tire pressure from the tire 708. The compressor 716 may be coupled to the engine 720 of the vehicle, such as tractor 108. That is, the engine 720 may provide the necessary energy or power for the compressor 716 to operate. Accordingly, the compressor 716 may provide pressured air having a pressure equal to or greater than the desired operating tire pressure to the tire 708. Although the controller 712 is depicted controlling an air pressure of a single tire 708, it should be understood that the controller 712 may control the air pressure of one or more tires of the vehicle, such as tractor 108 and the trailer 112. Alternatively, or in addition, a single controller 712 may control the air pressure of a single tire 708. In addition, one or more components, such as but not limited to the engine 720, compressor 716, air tank or reservoir 724, regulator 728, and/or sensor 742 may be common and/or shared between the one or more tires of the vehicle, such as tractor 108 and trailer 112.

FIG. 8 depicts a third example of an automatic tire inflation system 804 in accordance with examples of the present disclosure. Similar to the automatic tire inflation system 604 and 704, the automatic tire inflation system 804 generally acts on the tire 808; a tire pressure sensor 848 may provide a measurement, or quantity, of an internal tire pressure to a controller 812. For example, the tire pressure sensor 848 may measure an internal tire pressure and provide an indication, signal, or otherwise indicative of an internal tire pressure of the tire 808 to the controller 812. The indication, signal, or otherwise may be in the form of an analog or digital signal or quantity representative of the internal tire pressure of the tire 808. In some aspects, the controller 812 may cause the received tire pressure from the tire pressure sensor 848 to be stored in memory, a database, and/or provided to another device, such as a server, database, or otherwise, that is separate and distinct from the automatic tire inflation system 804. For example, the controller 812 may communicate with a network and provide such measured and received tire pressure to another location communicatively coupled to the network.

In some examples, the controller 812 may determine, calculate, or otherwise generate a desired quantity corresponding to an operating tire pressure based on the received tire pressure. The desired quantity, for example, may be the desired operating tire pressure, a total amount of additional air necessary to reach the operating tire pressure, and/or a difference between the sensed pressure and the desired operating tire pressure. In some examples, the desired quantity corresponding to the operating tire pressure may be based on additional parameters, such as weather conditions, tire location, tire type, tire condition (tread condition), load, pavement, etc. provided by a sensor 852. In some examples, the controller 812, based on the received tire pressure, may cause a regulator, or valve, 840 to open or close. That is, pressurized air may be provided by a compressor 816 communicatively coupled to the tire 808 via an air pressure line 844. The compressor 816 may provide pressured air that is less than the desired operating pressure to a pressured air tank, or reservoir 826. That is, the air tank, or reservoir, 826 may store pressurized air that is less than the determined desired operating tire pressure.

In some examples of the present disclosure, the desired operating tire pressure, such as the desired operating pressure 412 and/or 512, may be greater than an air pressure provided to one or more auxiliary systems 824, such a braking system, horn, and/or suspensions system. Accordingly, a booster 828 may boost pressurized air stored in the air tank or reservoir 826, to a pressure that is greater than or equal to the desired operating pressure, such as the desired operating pressure 412 and/or 512. The booster 828 may provide air having a greater air pressure to the air tank, or reservoir, 832 and may be operatively coupled to a power takeoff of the engine 820 or receive power from a generator or battery, for example. Thus, pressurized air corresponding to a desired operating tire pressure may be provided from the air tank, or reservoir, 832 to a regulator, or valve, 840. The regulator, or valve 840, may provide a regulated amount of pressurized air from the air tank, or reservoir, 832 to the tire 808, via the air pressure line 844. The tire 808 may include a tire stem coupled to the air pressure line 844 such that the tire stem may provide a pathway for pressurized air to enter the tire 808 and/or exit the tire 808 while the tire 808 is rotating for example. In some instances, the tire stem may allow pressurized air to escape from the tire 808 via the regulator, or valve, 840, which may act as a pressure bleeder valve for example, to bleed excess tire pressure from the tire 808. The compressor 816 may be coupled to the engine 820 of the vehicle, such as tractor 108. Accordingly, the compressor 816 may correspond to a standard, or stock air compressor, such that the booster 828 provides the compressed air to the tire 808.

Although the controller 812 is depicted controlling an air pressure of a single tire 808, it should be understood that the controller 812 may control the air pressure of multiple tires of the vehicle, such as tractor 108 and the trailer 112. Alternatively, or in addition, a single controller 812 may control the air pressure of a single tire 808. In addition, one or more components, such as but not limited to the engine 820, compressor 816, air tank or reservoir 832, regulator or valve 840, booster 828, and/or sensor 852 may be common and/or shared between the one or more tires of the vehicle, such as tractor 108 and trailer 112.

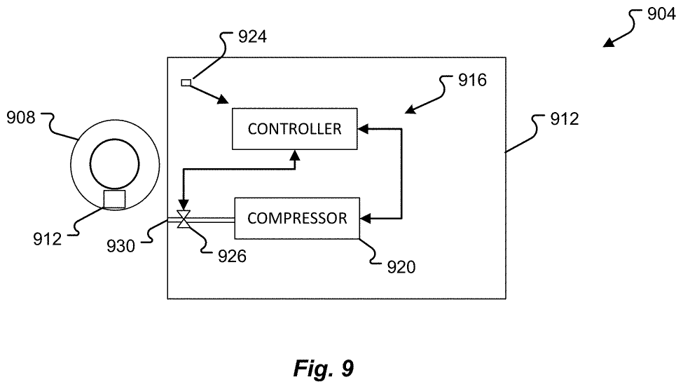

FIG. 9 depicts a fourth example of an automatic tire inflation system 904 in accordance with examples of the present disclosure. The automatic tire inflation system 904 generally acts on the tire 908. The automatic tire inflation system 904 may include a tire pressure sensor 924, controller 916, and compressor 920 that resides within or as part of the tire 908. Stated another way, the automatic tire inflation system 904 may include a substantially self-contained system 912 that includes the tire pressure sensor 924, the controller 916, and the compressor 920. Accordingly, rather than coupling a compressor to the engine of the vehicle, such as tractor 108, the rolling action of the tire 908 may provide the necessary movement to generate power to power the controller 916, tire pressure sensor 924, and/or to generate compressed air having an air pressure greater than or equal to the desired operating tire pressure. Thus, the tire pressure sensor 924 may provide a measurement, or quantity, of an internal tire pressure to the controller 916. For example, the tire pressure sensor 924 may measure an internal tire pressure and provide an indication, signal, or otherwise indicative of an internal tire pressure of the tire 908 to the controller 916. The indication, signal, or otherwise may be in the form of an analog or digital signal or quantity representative of the internal tire pressure of the tire 908. In some aspects, the controller 916 may cause the received tire pressure from the tire pressure sensor 924 to be stored in memory, a database, and/or provided to another device, such as a server, database, or otherwise, that is separate and distinct from the automatic tire inflation system 904. For example, the controller 916 may communicate with a network and provide such measured and received tire pressure to another location communicatively coupled to the network.

In some examples, the controller 916 may determine, calculate, or otherwise generate a desired quantity corresponding to an operating tire pressure based on the received tire pressure. The desired quantity, for example, may be the desired operating tire pressure, a total amount of additional air necessary to reach the operating tire pressure, and/or a difference between the sensed pressure and the desired operating tire pressure. In some examples, the desired quantity corresponding to the operating tire pressure may be based on additional parameters, such as weather conditions, tire location, tire condition (tread condition), load, pavement, etc. In some examples, the controller 916, based on the received tire pressure, may cause a regulator 926, such as a valve, to open or close. That is, pressurized air may be provided by a compressor 920 communicatively coupled to the tire 908 via an air pressure line 930. The regulator 926 may regulate an amount of pressurized air to flow from the compressor 920 via the air pressure line 930 to the tire 908. The tire 908 may include a tire stem coupled to the air pressure line 930 such that the tire stem may provide a pathway for pressurized air to enter the tire 908 and/or exit the tire 908 while the tire 908 is rotating for example. In some instances, the tire stem may allow pressurized air to escape from the tire 908 via the regulator 926, which may act as a pressure bleeder valve for example, to bleed excess tire pressure from the tire 908.

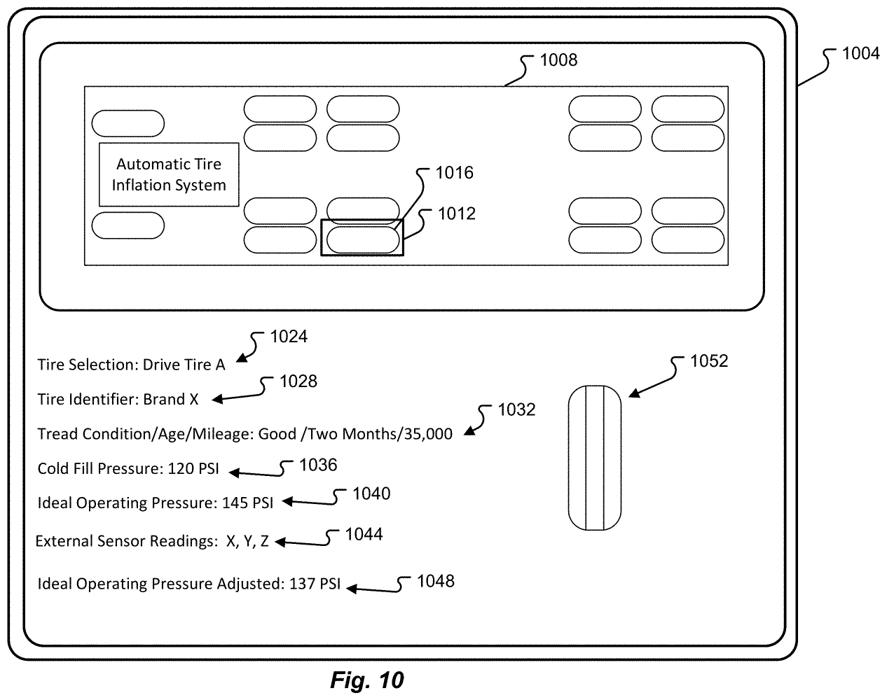

FIG. 10 depicts a user interface for interacting with one or more of the automatic tire inflation systems 604, 704, 804, and/or 904. The user interface 1004 may be displayed at a display of an instrument cluster for the vehicle, or on a desktop, laptop, tablet, smartphone, or other mobile device. The user interface 1004 may include a depiction 1008 of one or more tires of the vehicle, such as tractor 108 and trailer 112. In some examples, a user may interact with the depiction 1008 to select one or more tires, for example, 1016 as indicated by a selection indicator 1012. In some examples one or more of the tires in the depiction 1008 may not be coupled to the automatic tire inflation system and therefore may not be selected. For each of the tires coupled to the automatic tire inflation system, when selected, information and/or one or more parameters of the selected tire may be displayed. For example, tire information 1024 corresponding to the tire location may be displayed, where in some instance, the information displayed may uniquely identify the tire. In some examples, tire information 1028 may display a brand and/or other tire identification information; tire information 1032 may provide but is not limited to tire condition information such as an age of the tire, a tread condition, how many miles the tire has been used, etc. The tire information 1036 may correspond to the cold inflation tire pressure and may be based on one or more of the previously described pieces of tire information 1024, 1028, and/or 1032. For example, a cold inflation tire pressure 1036 may vary based on mileage or other parameter. Ideal operating pressure 1040 may correspond to an ideal operating pressure provided by the tire manufacturer. In examples, the ideal operating pressure 1040 may comprise the desired operating tire pressure corresponding to 412 and/or 512. In some instance, the ideal operating pressure 1040 may be retrieved from storage or otherwise generated by a controller, such as the controller 616, 712, 812, and/or 924. In some instances, external sensor readings 1044 may be displayed at the user interface 1004. The external sensor readings may correspond to one or more external sensors including but not limited to weather, tire location, tire wear, pavement condition, whether the automatic tire inflation system has been activated, and/or whether one or more other vehicle systems have been activated, such as cruise control, etc. Based on one or more of the cold inflation tire pressure 1036, the ideal operating pressure 1040, and/or the external sensor readings 1044, an adjusted ideal operating tire pressure 1048 may be calculated, generated, or otherwise determined by a controller, such as the controller 616, 712, 812, and/or 924. In examples, the adjusted ideal operating tire pressure 1048 may correspond to the desired operating tire pressure of 412 and/or 512. As discussed herein, the adjusted ideal operating tire pressure may comprise the ideal operating pressure 1040 adjusted based on additional parameters such as tire type, tire location, tire condition (including tire age and tire tread), weather, temperature, and other factors. In some examples, the user interface 1004 may include a depiction or image 1052 of the tire for identification and verification purposes.

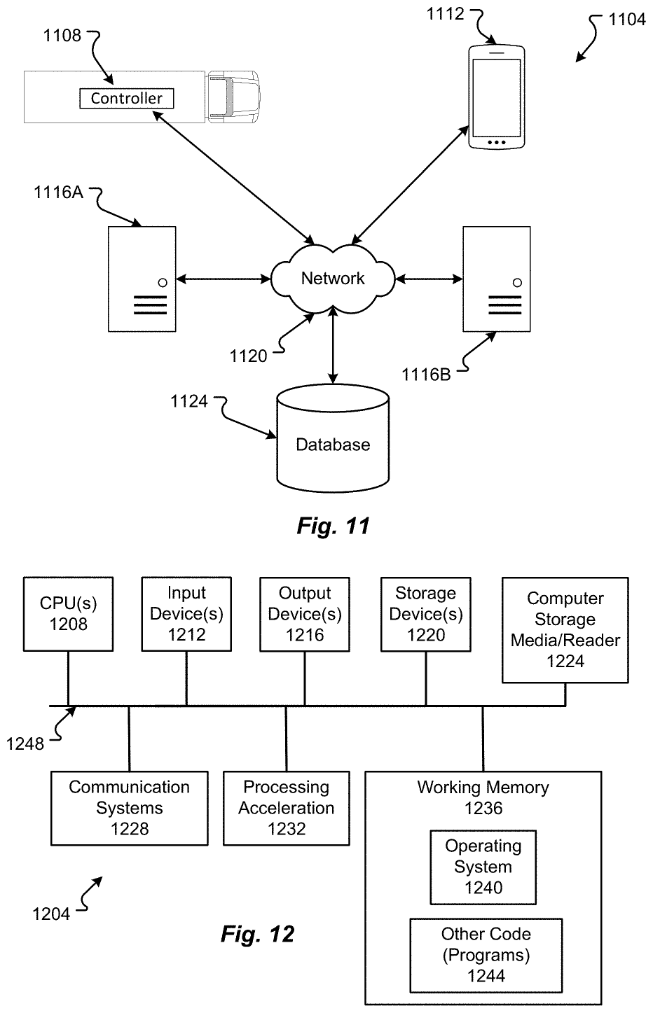

FIG. 11 depicts a computing environment 1104 that may provide and/or maintain air pressure information for one or more tires of the vehicle, such as tractor 108 and trailer 112 a described herein and in accordance with examples of the present disclosure. The computing environment 1104 may include one or more computing devices or controllers 1108, a communication device 1112, and/or other devices. The computing devices 1108 and 1112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. In some examples, the computing device 1108 corresponding to one or more of the previously described controllers may be a specifically programmed computing device for controlling the air pressure in one or more tires. In some examples, the controller 1108 may perform other functions, such as but not limited to navigation, safety management, location tracking, engine performance and diagnostics, and/or other functions generally associated with a vehicle, such as tractor 108 and trailer 112.

The computing devices 1108 and 1112 may also have any of a variety of applications, including for example, database client and/or server applications, and web browser applications. Alternatively, the computing devices 1108 and/or 1112 may be any other electronic device, such as a thin-client computer, Internet-enabled mobile telephone, and/or personal digital assistant, capable of communicating via a network 1120 and/or displaying and navigating web pages or other types of electronic documents. Although the computing environment 1104 is shown with a plurality of computing devices, any number of user computers or computing devices may be supported.

The computing environment 1104 may also include one or more servers 1116A and 1116B. In this example, server 1116A and server 1116B may include one or more applications accessible by a client running on one or more of the computing devices 1108 and/or 1112. In at least some configurations, one or more of the servers 1116A and/or 1116B may provide and/or maintain tire information such as a tire identification, cold inflation tire pressure, operating tire pressure, tire condition, tire location information, and the like. The server(s) 1116A and 1116 may be one or more general purpose computers capable of executing programs or scripts in response to the computing devices 1108 and/or 1112. The computing environment 1104 may also include a database 1124. The database 1124 may reside in a variety of locations. By way of example, database 1124 may reside on a storage medium local to (and/or resident in) one or more of the computers 1108 and/or 1112 and/or one or more servers 1116A/1116B. Alternatively, the database 1124 may be remote from any or all of the computers 1108 and/or 1112 and in communication (e.g., via the network 1120) with one or more of the computers 1108 and/or 1112. The database 1124 may reside in a storage-area network (“SAN”) familiar to those skilled in the art.

FIG. 12 illustrates one example of a computer system 1204 upon which the servers 1116A and/or 116B, user computers 1108 and/or 1112, computing devices, or other systems or components described above may be deployed or executed. In examples, the computer system may be integrated into the vehicle. The computer system 1204 is shown comprising hardware elements that may be electrically coupled via a bus 1248. The hardware elements may include one or more central processing units (CPUs) 1208; one or more input devices 1212 (e.g., a mouse, a keyboard, etc.); and one or more output devices 1216 (e.g., a display device, a printer, etc.). The computer system 1204 may also include one or more storage devices 1220. By way of example, storage device(s) 1220 may be disk drives, optical storage devices, solid-state storage devices such as a random access memory (“RAM”) and/or a read-only memory (“ROM”), which can be programmable, flash-updateable and/or the like.

The computer system 1204 may additionally include a computer-readable storage media/reader 1224; a communications system 1228 (e.g., a modem, a network card (wireless or wired), an infra-red communication device, etc.); and working memory 1236, which may include RAM and ROM devices as described above. The computer system 1204 may also include a processing acceleration unit 1232, which can include a digital signal processor (DSP), a special-purpose processor, and/or the like.

The computer-readable storage media/reader 1224 can further be connected to a computer-readable storage medium, together and, optionally, in combination with storage device(s) 1220 comprehensively representing remote, local, fixed, and/or removable storage devices plus storage media for temporarily and/or more permanently containing computer-readable information. The communications system 1228 may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The term computer-readable media as used herein may include computer storage media. Computer storage media may include volatile and nonvolatile, removable and non-removable media implemented in any method or technology for storage of information, such as computer readable instructions, data structures, or program modules. Computer storage media does not include a carrier wave or other propagated or modulated data signal.

The computer system 1204 may also comprise software elements, shown as being currently located within a working memory 1236, including an operating system 1240 and/or other code 1244. It should be appreciated that alternate examples of a computer system 1204 may have numerous variations from that described above. For example, customized hardware might also be used and/or particular elements might be implemented in hardware, software (including portable software, such as applets), or both. Further, connection to other computing devices such as network input/output devices may be employed.

The processor 1208 may include central processing units (CPU's), microcontrollers (MCU), digital signal processors (DSP), application specific integrated circuits (ASIC), and the like. The processor interchangeably refers to any type of electronic control circuitry configured to execute programmed software instructions. The programmed instructions may be high-level software instructions, compiled software instructions, assembly-language software instructions, object code, binary code, micro-code, or the like. The programmed instructions may reside in internal or external memory. In some examples, one or more processors 1208 may be hardware specifically configured or hardwired to perform at least some of the operations described herein. For instance, one or more processors 1208 may include application specific integrated circuits (ASICs), field programmable gate arrays (FPGAs), system-on-a-chip (SoC), or other specialized or customizable computing hardware. In some examples, some or all of the one or more processors 1208 may be part of a controller configured to interface with components on the vehicle and perform the operations described herein.

The controller 1108 and/or one or more of the computing devices 1112 may receive and/or store information associated with one or more tires and one or more tire pressures utilizing a data structure 1300, where the data structure may be stored in one or more previously described storage locations and/or database 1124. The data structure may include, but is not limited to, information associated with a tire identifier 1304, an optimal fill pressure 1308, a calculated operating tire pressure 1312, age/tread/mileage information 1316, and/or a cold inflation tire pressure. There may be more or fewer fields in data structure 1300, as represented by ellipses 1324. Further, each tire can have a data structure 1300 as represented by ellipses 1320.

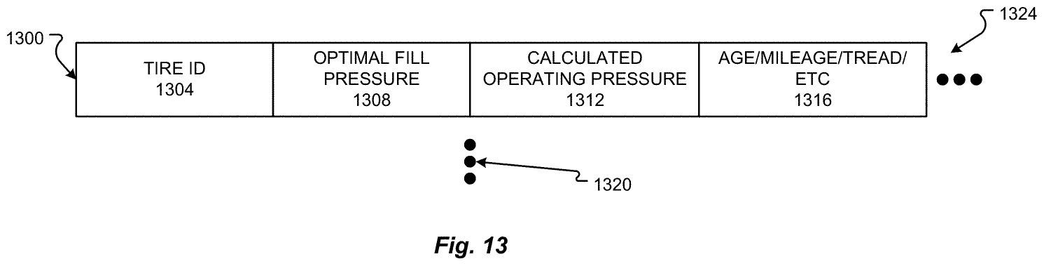

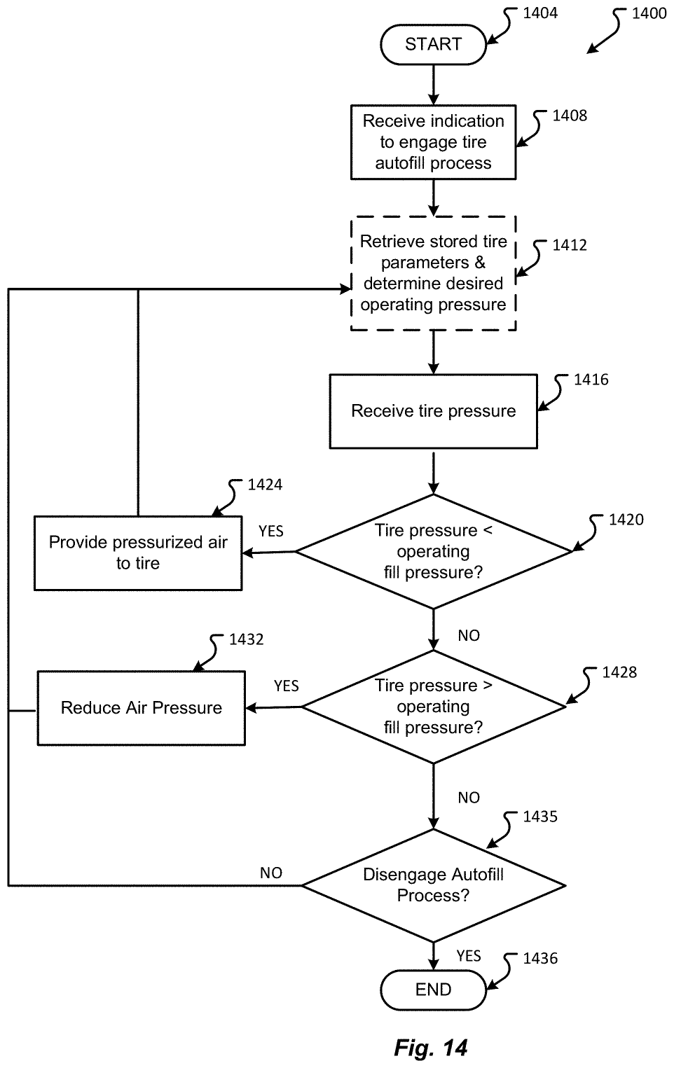

FIG. 14 shows a method 1400 for adjusting an air pressure of one or more tires of a vehicle, such as tractor 108 and/or a trailer 112, in accordance with examples of the present disclosure. A general order for the steps of the method 1400 is shown in FIG. 14. Generally, the method 1400 starts with a start operation 1404 and ends with an end operation 1436. The method 1400 can include more or fewer operations or can arrange the order of the steps differently than those shown in FIG. 14. The method 1400 can be executed as a set of computer-executable instructions executed by a computer system and encoded or stored on a computer readable medium. Further, the method 1400 can be performed by gates or circuits associated with a processor, an ASIC, a FPGA, a SOC, or other hardware device. Hereinafter, the method 1400 shall be explained with reference to the systems, components, devices, modules, software, signals, data structures, interfaces, methods, etc. described in conjunction with FIGS. 1-13.

The method 1400 may flow from the start operation 1404 to 1408, where an indication to engage a tire autofill process may be received. The indication to engage a tire auto fill process may correspond to one or more sensed quantities received at a sensor 742, and/or 852, and/or 924 for example. As one non-limiting example, the indication to engage a tire auto fill process may correspond to an engagement of cruise control. For example, when a driver or other entity engages a cruise control function of the vehicle, such as tractor 108, an indication to engage the tire autofill process may be received at 1408. As another non-limiting example, the indication to engage a tire auto fill process may correspond to starting of the vehicle engine or sensing that the vehicle, such as tractor 108 and trailer 112, is moving at a velocity greater than a velocity threshold. For example, when the vehicle, such as tractor 108 and/or trailer 112, moves at a rate that is greater than 25 km/h, an indication to engage the tire autofill process may be received automatically at 1408. As another non-limiting example, the indication to engage a tire auto fill process may correspond to a location of the vehicle, such as tractor 108 and/or trailer 112; for example, as a tractor 108 and/or trailer 112 enter a highway, an indication to engage the tire autofill process may be received at 1408. As another non-limiting example, the indication to engage a tire auto fill process may be associated with an activation of a specific transmission gear and/or an activation of the vehicle ignition. As another non-limiting example, the indication to engage a tire auto fill process may correspond to a driver or other entity toggling a switch within the vehicle, such as tractor 108, selecting a function or functionality at a user interface such as the user interface 1004, or combination of one of the previously described indication to engage the tire auto fill process.

The method 1400 may then flow to 1412, where the one or more stored tire parameters may be retrieved and a desired operating tire pressure may be determined. For example, a stored tire parameter may correspond to a cold inflation tire pressure and/or an ideal operating tire pressure provided by the tire manufacturer or determined as a default based on ideal operating conditions. In examples, the desired operating tire pressure may comprise the ideal operating tire pressure. However, the ideal operating tire pressure may be based on assumptions of clear conditions, good tread left on the tires, and certain temperature ranges. In one non-limiting example, rather than retrieve the desired operating tire pressure, the method 1400 may determine a desired operating tire pressure that is different from the ideal operating pressure based on one or more retrieved tire parameters. For example, a cold inflation tire pressure for a specific tire may be retrieved; a desired operating tire pressure may then be determined based on a determination that tire pressure should be increased by thirty PSI or other set amount of pressure (or percentage of the cold inflation tire pressure). Such tire parameters may be received from a database 1124 and/or other storage devices 1220 and may be stored in the data structure 1300. The tire parameters retrieved at 1412 may correspond to one or more tire parameters entered at the user interface 1004, and may also include user preferences, sensed weather conditions, vehicle speed or mode (e.g., cruise control), tire conditions (including tire tread condition and tire age), desired fuel mileage preference, and/or freight ton efficiency preferences for example. The retrieved tire parameters may correspond to a selected tire 1016 at the user interface 1004.

In examples, the tire parameters may further include weather conditions that are either directly received at the tire autofill system (e.g., Internet weather reports regarding whether precipitation is happening in the area) or inferred by a controller of the tire autofill system by monitoring other vehicle systems (e.g., determining that precipitation is occurring based on windshield wipers have been turned on for over a threshold amount of time). In addition, conditions of the tire(s) may also be determined based on other systems of the vehicle. For example, user interface 1004 may be used to receive information from a user/driver when a new tire has been installed on the vehicle, the brand of tire, etc. The condition of the tire may then be inferred by the tire autofill system based on the time since such new tire was installed and a number of miles traveled by the vehicle (e.g., based on monitoring the odometer) since the new tire was installed. For example, the tire autofill system may store manufacturer information regarding the expected tread wear on a particular brand/type of tire for a particular vehicle and/or tire age.

The received or inferred tire parameters can then be used to determine 1412 the desired operating tire pressure. In examples, the desired operating tire pressure may be determined based on a variety of factors. For example, the desired operating tire pressure may be based on a cold inflation tire pressure provided by the tire manufacturer plus a standard increase amount or percentage of pressure for the particular tire to determine an ideal operating tire pressure. However, the ideal operating tire pressure may be further adjusted (as described above) based on additional tire parameters (such as tire condition and weather, temperature, vehicle location, etc.) to arrive at a desired operating tire pressure that is different from the ideal operating tire pressure.

The desired operating tire pressure may be determined 1412 periodically or continuously determined based on changing tire parameters until a signal is received to disengage the autofill process, as described below.

The method 1400 may proceed to 1416 where a current or otherwise recent tire pressure may be received. For example, the tire pressure sensor 612, 740, 848, and/or 924 may provide a current, recent-in-time, periodic, or otherwise real-time tire pressure for a tire of the vehicle, such as tractor 108 and/or the trailer 112. In some examples, the current or otherwise recent tire pressure may correspond to a selected tire 1016 at the user interface 1004. The method 1400 may proceed to 1420, where the tire pressure received at 1416 may be compared to a desired operating tire pressure. In some instances, the desired operating tire pressure may be specific to a tire; in other instances, the desired operating tire pressure may be generated or otherwise determined for one or more tires of the vehicle, such as tractor 108 and/or trailer 112. If, at 1420, the tire pressure received at 1416 is less than the desired operating tire pressure, the method may proceed to 1424, where one or more regulators, and/or valves, may be modulated to provide an increase in air pressure to the desired tire. As one non-limiting example, the controller 616 may cause the regulator or valve 632 to open allowing pressurized air to enter the air pressure line 628; the air may then flow into a tire stem, or other tire inlet, thereby increasing the tire pressure of the tire. The regulator or valve, such as the regulator or valve 632 may be opened for a quantity period of time, which may be calculated or otherwise determined based on a difference between the received current tire pressure and the desired operating tire pressure. For example, a quantity period of time for a five PSI difference between the received current tire pressure and the desired operating tire pressure may be less than a quantity period of time for a ten PSI difference between the received current tire pressure and the desired operating tire pressure. In some non-limiting examples, the regulator or valve, such as the regulator or valve 632 may remain open until the tire pressure is equal to or greater than the desired operating tire pressure. In other non-limiting examples, the regulator or valve, such as the regulator or valve 632 may open for discrete periods of time as previously discussed such that method portions 1412, 1416, 1420, and 1424 flow in a loop until the tire pressure is equal to the desired operating tire pressure. The automatic tire inflation system 704, 804, and/or 904 may operate in a similar manner to that of the automatic tire inflation system 604 when increasing a pressure of a specified tire.

The method 1400 may proceed to 1428, where the tire pressure received at 1416 may be compared to a desired operating tire pressure. In examples, the tire pressure may be received at operation 1416 periodically, and the received tire pressure may be compared to the desired operating tire pressure each time that it is received. In some instances, the desired operating tire pressure may be specific to a tire; in other instances, the desired operating tire pressure may be generated or otherwise determined for one or more tires of the vehicle, such as tractor 108 and/or trailer 112 as previously discussed. If, at 1428, the tire pressure received at 1416 is greater than the desired operating tire pressure, the method may proceed to 1432, where one or more regulators, and/or valves, may be modulated to release, or bleed, air from the specified tire to reduce the tire pressure to the desired operating pressure. As one non-limiting example, the controller 616 may cause the regulator or valve 632, or another regulator or valve, to open allowing pressurized air from the specified tire to escape from the tire. This may be required, for example, if the tire is filled to the desired operating tire pressure and then the tire continues to heat and/or conditions change thereby causing the actual tire pressure to continue to increase. In other examples, the desired tire pressure may be decreased, thereby causing the actual tire pressure to exceed the newly determined desired tire pressure. The regulator or valve, such as the regulator or valve 632 may be opened for a quantity period of time, which may be calculated or otherwise determined based on a difference between the received current tire pressure and the desired operating tire pressure. For example, a quantity period of time for a five PSI difference between the received current tire pressure and the desired operating tire pressure may be less than a quantity period of time for a ten PSI difference between the received current tire pressure and the desired operating tire pressure. In some non-limiting examples, the regulator or valve, such as the regulator or valve 632 may remain open until enough air has been removed from the specified tire such that the tire pressure is equal to or less than the desired operating tire pressure. In other non-limiting examples, the regulator or valve, such as the regulator or valve 632 may open for discrete periods of time as previously discussed such that method operations 1412, 1416, 1428, and 1432 flow in a loop until the tire pressure is equal to the desired operating tire pressure. The automatic tire inflation system 704, 804, and/or 904 may operate in a similar manner to that of the automatic tire inflation system 604 when decreasing pressure of a specified tire. Once the desired operating tire pressure has been achieved, that is the tire pressure received at 1416 is equal to the desired operating pressure, where the desired operating pressure is greater than the cold inflation pressure by a specific amount in some instances, the method 1400 may proceed to operation 1435, where it is determined whether the autofill process has been disengaged.

In examples, the autofill process may be disengaged when a signal is received through a user interface, such as user interface 1004, indicating to disengage the tire autofill process. In other examples, if the signal to engage the tire autofill process was received at operation 1408 when a cruise control system is engaged, the disengagement of the cruise control system for the vehicle may also cause the automatic disengagement of the tire autofill process at operation 1435. Alternatively, disengagement of the cruise control system may cause a recalculation of the desired operating pressure at operation 1412 to a lower desired operating pressure (thereby causing the pressure in the subject tire(s) to be reduced at operation 1432). For example, a driver of the vehicle may desire less tire pressure for better road grip as a safety measure once cruise control is disengaged. If the autofill process has not been determined to have been disengaged at operation 1435, the method 1400 may loop back to determine again the desired operating pressure at operation 1412. For example, as discussed, the desired operating pressure may be determined to be lower or higher upon the method 1400 looping back to operation 1412 based on changing tire parameters (such as weather conditions, temperature, vehicle speed, etc.).

When a signal is received indicating that the autofill process has been disengaged, the method 1400 ends at operation 1436.

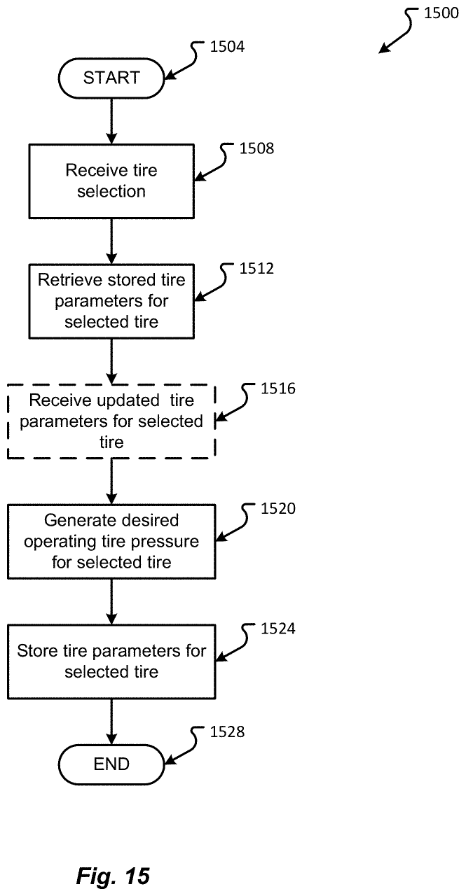

FIG. 15 shows a method 1500 for providing and/or updating one or more tire parameters for one or more tires of a vehicle, such as tractor 108 and/or a trailer 112, and determining a desired operating tire pressure in accordance with examples of the present disclosure. For example, method 1500 may be used in connection with operation 1412 of method 1400. A general order for the steps of the method 1500 is shown in FIG. 15. Generally, the method 1500 starts with a start operation 1504 and ends with an end operation 1528. The method 1500 can include more or fewer steps or can arrange the order of the steps differently than those shown in FIG. 15. The method 1500 can be executed as a set of computer-executable instructions executed by a computer system and encoded or stored on a computer readable medium. Further, the method 1500 can be performed by gates or circuits associated with a processor, an ASIC, a FPGA, a SOC, or other hardware device. Hereinafter, the method 1500 shall be explained with reference to the systems, components, devices, modules, software, signals, data structures, interfaces, methods, etc. described in conjunction with FIGS. 1-14.

The method 1500 may flow from the start operation 1504 to 1508, where a tire selection may be received. For example, a user may select a tire 1016 from the user interface 1004 and a selection indicator 1012 may form around the selected tire 1016. Accordingly, an indication that the tire 1016 has been selected may be received at 1508. The method 1500 may proceed to 1512, where one or more stored tire parameters may be retrieved. For example, the stored tire parameter may correspond to a cold fill tire pressure, a desired operating tire pressure, a tire type, a tire age, etc. Such tire parameters may be received from a database 1124 and/or other storage devices 1220 and may be stored in the data structure 1300. The tire parameters retrieved at 1512 may correspond to one or more tire parameters entered at the user interface 1004 and may be modified in accordance with a user preference, fuel mileage preference, tire conditions, and/or freight ton efficiency preference for example and as described herein. The retrieved tire parameters generally correspond to the selected tire 1016 at the user interface 1004 at 1508.

At 1516, one or more updated tire parameters for the selected tire 1016 may be received. For example, a user may enter into the user interface 1004 an updated value for a tire parameter, such as a cold inflation tire pressure. As another non-limiting example, a user may enter into the user interface 1004 an updated value for a tire parameter, such as a tire condition. As another example, one or more parameters for the selected tire 1016 may be automatically calculated and/or received. That is, one or more parameters may be updated in real-time. In some example, 1516 may be optional, that is one or more parameters may not require updating and therefore may not be received at 1516. Method 1500 may then proceed to 1520, where a desired operating tire pressure for the selected tire 1016 is generated. More specifically, based on a cold inflation tire pressure and one or more tire parameters, such as but not limited to a percent increase in tire pressure, a condition of the selected tire 1016, pavement conditions, a tire identifier, weather conditions, and/or trailer loading conditions, a desired operating tire pressure for the selected tire may be generated. In some examples, the operating tire pressure for the selected tire may be generated in real-time and may not require the user interface for updating the tire pressure. Moreover, an operating tire pressure may be generated for a specific tire; that is, tires of the vehicle (such as tractor 108 and trailer 112) may have different generated operating tire pressures. At 1524, the updated tire parameters and/or the generated operating tire pressure for the selected tire 1016 may be stored, for example in the database 1124, storage device(s) 1220, or working memory 1236. Method 1500 may end at 1528.

The above specification, examples and data provide a complete description of the manufacture and use of the composition of the invention. The description and illustration of one or more aspects provided within this disclosure are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure, in various configurations and aspects, includes components, methods, processes, systems and/or apparatus substantially as depicted and described herein, including various combinations, sub combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved. While the flowcharts have been discussed and illustrated in relation to a particular sequence of events, it should be appreciated that changes, additions, and omissions to this sequence can occur without materially affecting the operation of the disclosed configurations and aspects. Any of the steps, functions, and operations discussed herein can be performed continuously and automatically.

One or more systems and methods of this disclosure have been described in relation to computing and/or processing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein. A number of variations and modifications of the disclosure can be used. It would be possible to provide for some features of the disclosure without providing others.

In yet other configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet other configurations, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet other configurations, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

What is claimed is:

1. A tire inflation system comprising:
a tire pressure sensor operatively coupled to a vehicle tire;
a compressor configured to provide compressed air to the vehicle tire;
a valve between the compressor and the vehicle tire; and
a controller configured to:
access a tire parameter associated with the vehicle tire;
determine a cold inflation tire pressure of the vehicle tire;
determine an operating tire pressure for the vehicle tire based on the accessed tire parameter and the cold inflation tire pressure;
receive a tire pressure of the vehicle tire from the tire pressure sensor; and
when the tire pressure received from the tire pressure sensor is less than the operating tire pressure, cause the valve to pass pressurized air from the compressor to the vehicle tire, wherein the operating tire pressure is greater than the cold inflation tire pressure of vehicle tire.

2. The tire inflation system of claim 1, further comprising:
a regulator configured to provide pressurized air to an auxiliary system, wherein the air pressure of the pressurized air provided to the auxiliary system by the regulator is less than an air pressure of the pressurized air provided by the compressor.

3. The tire inflation system of claim 1, further comprising:
a pressure booster disposed between the compressor and the vehicle tire, the pressure booster configured to increase a pressure of the pressurized air supplied by the compressor to an air pressure that is greater than or equal to the operating tire pressure.

4. The tire inflation system of claim 3, further comprising:
a first air tank disposed between the pressure booster and the compressor; and
a second air tank disposed between the pressure booster and the valve, wherein the second air tank contains air at an air pressure that is greater than the air pressure of the first air tank.

5. The tire inflation system of claim 1, wherein the controller is configured to increase the tire pressure of the vehicle tire to the operating tire pressure when the controller receives an operating tire pressure engagement indication, and wherein the operating tire pressure engagement indication is associated with at least one of an engagement of a cruise control functionality, a location of a vehicle associated with the vehicle tire, or a velocity of a vehicle associated with the vehicle tire.

6. The tire inflation system of claim 1, wherein the controller is further configured to:
determine a subsequent operating tire pressure based on a change in the received tire parameter;
cause the vehicle tire to be inflated or deflated to the subsequent operating tire pressure.

7. The tire inflation system of claim 1, wherein the controller is further configured to:
receive a subsequent tire pressure for the vehicle tire;
determine that the subsequent tire pressure for the vehicle tire exceeds the operating tire pressure; and
cause the valve to bleed air from the vehicle tire until the tire pressure for the vehicle tire is at or below the operating tire pressure.

8. The tire inflation system of claim 7, wherein the tire parameter is associated with at least one of a type of the vehicle tire, a length of time the vehicle tire has been in service, a distance associated with how far the vehicle tire has traveled, or a tread condition of the vehicle tire.

9. A method for inflating a vehicle tire, the method comprising:
accessing a tire parameter associated with the vehicle tire;
determining a cold inflation tire pressure of the vehicle tire;
determining an operating tire pressure for the vehicle tire based on the accessed tire parameter and the cold inflation tire pressure;
receiving a tire pressure of the vehicle tire from a tire pressure sensor; and
when the tire pressure received from the tire pressure sensor is less than the operating tire pressure, causing a valve to pass pressurized air from a compressor to the vehicle tire, wherein the operating tire pressure is greater than the cold inflation tire pressure of the vehicle tire.

10. The method of claim 9, further comprising:
receiving an indication to increase the tire pressure of the vehicle tire to the operating tire pressure, the indication being associated with at least one of an engagement of a cruise control functionality, a location of a vehicle associated with the vehicle tire, or a velocity of a vehicle associated with the vehicle tire.

11. The method of claim 9, further comprising:
receiving a subsequent tire pressure for the vehicle tire;
determining that the subsequent tire pressure for the vehicle tire exceeds the operating tire pressure; and
causing the valve to bleed air from the vehicle tire until the tire pressure for the vehicle tire is at or below the operating tire pressure

12. The method of claim 11, wherein the tire parameter is associated with at least one of a tire type, a length of time the tire has been in service, a distance associated with how far the tire has traveled, or a tread condition of the tire.

13. The method of claim 11, further comprising:
determining a subsequent operating tire pressure based on a change in the received tire parameter; and
causing the vehicle tire to be inflated or deflated to the subsequent operating tire pressure.

14. The method of claim 9, further comprising:
receiving, at a user interface, a selection of the vehicle tire;
displaying the tire parameter at the user interface;
receiving, at the user interface, an updated tire parameter; and
storing the updated tire parameter.

15. A vehicle comprising:
a plurality of vehicle tires;
a plurality of tire pressure sensors, each pressure sensor of the plurality of pressure sensors being coupled to a vehicle tire of the plurality of vehicle tires;
a compressor configured to provide compressed air to the plurality of vehicle tires;
at least one valve between the compressor and the plurality of vehicle tires; and
a controller configured to:
access a tire parameter associated with each vehicle tire of the plurality of vehicle tires;
determine a cold inflation tire pressure of the vehicle tire;
determine an operating tire pressure for the vehicle tire based on the accessed tire parameter and the cold inflation tire pressure;
receive a tire pressure of each vehicle tire from a respective tire pressure sensor; and
when a tire pressure of a respective vehicle tire is less than the operating tire pressure, cause the at least one valve to pass pressurized air from the compressor to the vehicle tire, wherein the operating tire pressure is greater than the cold inflation tire pressure of the respective vehicle tire.

16. The vehicle of claim 15, further comprising:
a regulator configured to provide pressurized air to a vehicle auxiliary system, wherein the air pressure of the pressurized air provided to the vehicle auxiliary system is less than an air pressure of the pressurized air provided by the compressor.

17. The vehicle of claim 15, further comprising:
a pressure booster disposed between the compressor and the plurality of vehicle tires, the pressure booster configured to increase a pressure of the pressurized air supplied by the compressor to an air pressure that is greater than or equal to the operating tire pressure.

18. The vehicle of claim 17, further comprising:
a first air tank disposed between the pressure booster and the compressor; and
a second air tank disposed between the pressure booster and the at least one valve, wherein the second air tank contains air at an air pressure that is greater than the air pressure of the first air tank.

19. The vehicle of claim 15, the controller is further configured to:
receive a subsequent tire pressure for the vehicle tire;
determine that the subsequent tire pressure for the vehicle tire exceeds the operating tire pressure; and
cause the valve to bleed air from the vehicle tire until the tire pressure for the vehicle tire is at or below the operating tire pressure.

20. The vehicle of claim 19, wherein the tire parameter is associated with at least one of a tire type, a length of time the respective vehicle tire has been in service, a distance associated with how far the respective vehicle tire has traveled, or a tread condition of the respective vehicle tire.
